(19) United States
(12) Patent Application Publication
(10) Pub. No.: US 2004/0249724 A1
(43) Pub. Date: Dec. 9, 2004

(54) Interactive ordering system for food service utilizing animated guide

(76) Inventor: Steven Roy Gosewehr, Plano, TX (US)

Correspondence Address: Steven R. Gosewehr, 2501 Glencliff, Plano, TX, 75075, US

(21) Appl. No.: 10/828,695

(22) Filed: Apr. 21, 2004

Related U.S. Application Data
(60) Provisional application No. 60/475,738, filed on Jun. 4, 2003.

(51) Int. Cl. G06F 17/60

(52) U.S. Cl. 705/26

(57) ABSTRACT

An interactive ordering system with animated guide that guides a customer or employee through the ordering process of a business. The animated guide is part of a software product that runs on a computer and receives and processes orders. The animated guide helps customers or employees through the ordering process by offering graphical and audio help in the form of tips, suggestions, and other forms of help that would normally be given by an employee. This new method of implementing an interactive ordering system makes it much easier for users to use ordering systems and saves time and money for business by saving on labor and training costs. The animated guide can come in many different forms including but not limited to cartoon characters and possibly even video-captured humans. The animated guide will be programmed specific to each system to provide help on the ordering process and to explain to the user how to use the system and to provide more information on items that could be ordered.

### CROSS-REFERENCE TO RELATED APPLICATIONS

This application claims the benefit of PPA Ser. No. 60/475738, filed Jun. 4, 2003 by present inventor.

### SEQUENCE LISTING

None.

### FEDERALLY SPONSORED RESEARCH

None.

### BACKGROUND OF THE INVENTION—FIELD OF INVENTION

This invention relates to methods of accepting and processing orders for food service businesses, specifically to electronic or computer-based methods of accepting and processing orders.

### BACKGROUND OF THE INVENTION

Businesses often have high-labor costs for employees to take orders from customers and to put those orders into the businesses' ordering-taking system. This not only means that businesses have to pay for employees to sit or stand there in the mundane task of processing orders, but they also have to be trained to use the business's specific order-processing system. Advances in electronic and computer systems have sped up the order-input process for these employees, but most of these systems still need to have employees work the systems. More recent advances have come with systems that allow for customers to input their orders by themselves, such as those suggested by Bernstein, et al. in U.S. Pat. Nos. 5,761,071 (1998) and 6,078,848 (2000). However, these systems discuss only the use of browser technology in these kiosks to ease the interaction with the user. Another invention by Battistini, et al. discusses a means for communicating orders from a remote customer, such as one in a drive-thru, to a restaurant employee, which can also include video of the employee in U.S. Pat. No. 6,087,927 (2000). This system does not remove the costly time of the employee from the ordering process. One good example of a recent invention that removes the employee from the ordering process is that by Camaisa, et al. in U.S. Pat. No. 5,845,263 in which an interactive visual ordering system is described. This system allows the customer to find out information about the company's products and also allows them to complete the transaction through credit card or debit means. These interactive systems normally utilize Touchscreen technology that allows customers to touch the screen on the items that they would like to purchase. The problem, however, still remains that customers are uncomfortable using these systems; no matter how easy to use the design is. Even though most people in the U.S. own or have access to computers, still most of the people prefer to interact with a human being instead of a machine even if it is faster and more efficient for them. Many of these systems have been implemented and tried, but most have been removed after some time.

There have been a few examples of animated guides in information kiosks such as those developed by a company called Dreamlight. There was even one listed on their website developed for a prototype Kodak kiosk that involved film development transactions with a customer. However, these systems have failed to become popular because of reasons such as high cost because they are produced by multiple companies. One company might do the interface, while one might do the kiosk enclosure, and the main company might need to develop their own proprietary behind-the-interface software. In addition, insofar as I am aware, none of these systems have been designed for food-service industries.

In conclusion, insofar as I am aware, no customer-ordering device or system developed for the food service industry provides the comfortable and easy-to-use interactive interface that most customers would prefer and be willing to use and is also cost-effective for the food service establishment.

### BACKGROUND OF THE INVENTION—OBJECTS AND ADVANTAGES

Accordingly, several objects and advantages of this invention are:

(a) to provide a kiosk or interactive ordering system that humans as customers are interested and willing to interact with;

(b) to provide a kiosk or interactive ordering system that assists customers in making well-informed decisions in the food ordering process;

(c) to provide a kiosk or interactive ordering system that is cost-effective for the business to purchase and maintain;

(d) to provide a kiosk or interactive ordering system that lowers business' labor and training costs for their employees; and

(e) to provide a kiosk or interactive ordering system that speeds up the food ordering process so that business' will be able to serve more customers.

Still further objects and advantages will become apparent from a study of the following description and the accompanying drawings.

### SUMMARY

The invention, an improved interactive ordering system for food service, utilizes an animated guide on the display portion of a kiosk to assist a customer or employee through the order input and processing tasks so that the customer does not need an employee to assist them. The animated guide will stay on the screen at all times and will give audio and graphical assistance to customers in order to make the ordering process easy and efficient. The animated guide can take many forms depending on the application. Applications could be implemented whereby the animated guide could take any form from, possibly, a cartoon figure, to even a video clip of a person. The animated guide will be designed to match up with what the customer is seeing at that particular time and will offer tips, advice, or any other type of graphical or audio assistance that the customer might need. Basically, the animated guide will take the place of the employee that normally would take the customers' orders. The kiosk that utilizes the animated guide would be a normal kiosk that has been described and used previously and that would have a touchscreen display, a computer, a receipt printer, a credit card reader and/or a cash-accepting device, and other optional additional peripherals.

### DRAWINGS

FIG. 1 is a front view of the display showing a possible display with the animated guide as a cartoon character.

FIG. 2 is a front view of the display showing a possible display with the animated guide as a video-captured human.

FIG. 3 is a perspective front view of a possible system mock-up that uses a Touchscreen monitor, a computer with speaker(s), a credit card reader, and a receipt printer.

FIG. 4 shows a flowchart of a typical software interface diagram of the system.

FIG. 5 shows a flowchart of a possible customer interaction with the system.

### DETAILED DESCRIPTION

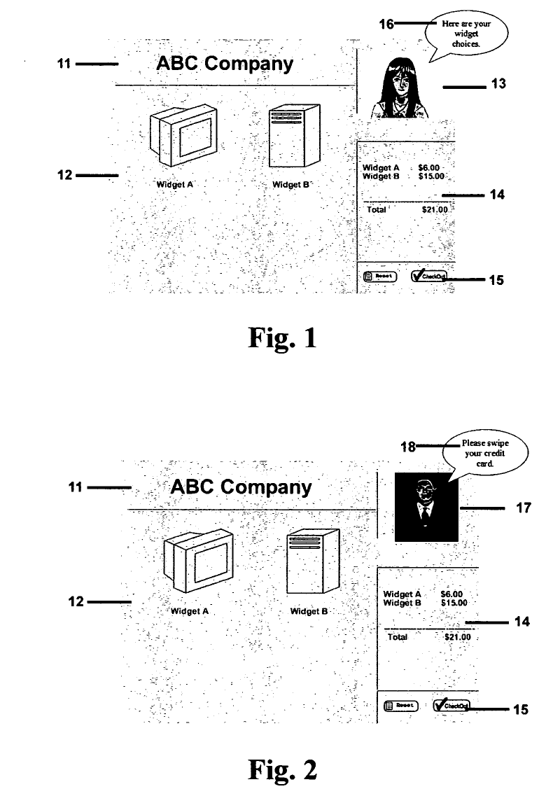

FIG. 1 is a front view of the display showing a possible screenshot with the animated guide constructed in accordance with the invention. The upper portion of the screen 11 shows the name of the business that is taking the order. The main portion 12 shows the choices available to the customer. The upper right portion 13 shows a cartoon animated guide that will talk to the customer to help them through the ordering process. The middle right portion 14 shows the current state of the customer's order. The bottom right portion 15 contains buttons that, in this configuration, allow the customer to continue with the ordering process, move to the checkout or payment transaction process, or to cancel their current order. This display is just one possibility that utilizes the animated guide to assist the customer with the ordering process.

FIG. 2 is a front view of the display showing a possible screenshot with the animated guide constructed in accordance with the invention. The upper portion of the screen 11 shows the name of the business that is taking the order. The main portion 12 shows the choices available to the customer. The upper right portion 17 shows a video-captured animated guide that will talk to the customer to help them through the ordering process. The middle right portion 14 shows the current state of the customer's order. The bottom right portion 15 contains buttons that, in this configuration, allow the customer to continue with the ordering process, move to the checkout or payment transaction process, or to cancel their current order. This display is just one possibility that utilizes the animated guide to assist the customer with the ordering process.

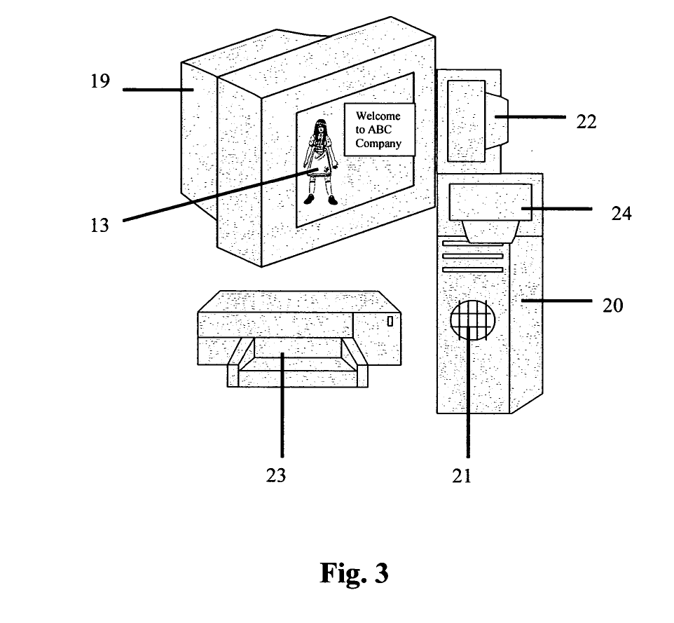

FIG. 3 is a perspective front view of a possible ordering and transaction processing system that uses a Touchscreen monitor 19, a computer 20 with speaker 21, a credit card reader 22, a cash-accepting device 24, and a receipt printer 23. The Touchscreen monitor 16 is where the customer interacts with the software and the animated guide. The computer 20 runs the software with the animated guide 13 and whatever hardware peripherals are connected. The speaker 21 is what allows the animated guide 13 to talk to the customer. The credit card reader 22 allows the customer to pay for their order at the system using credit or debit cards. The cash-accepting device 24 allows the customer to pay for their order at the system using paper currency. The receipt printer 23 prints out a record of the transaction for the customer's records.

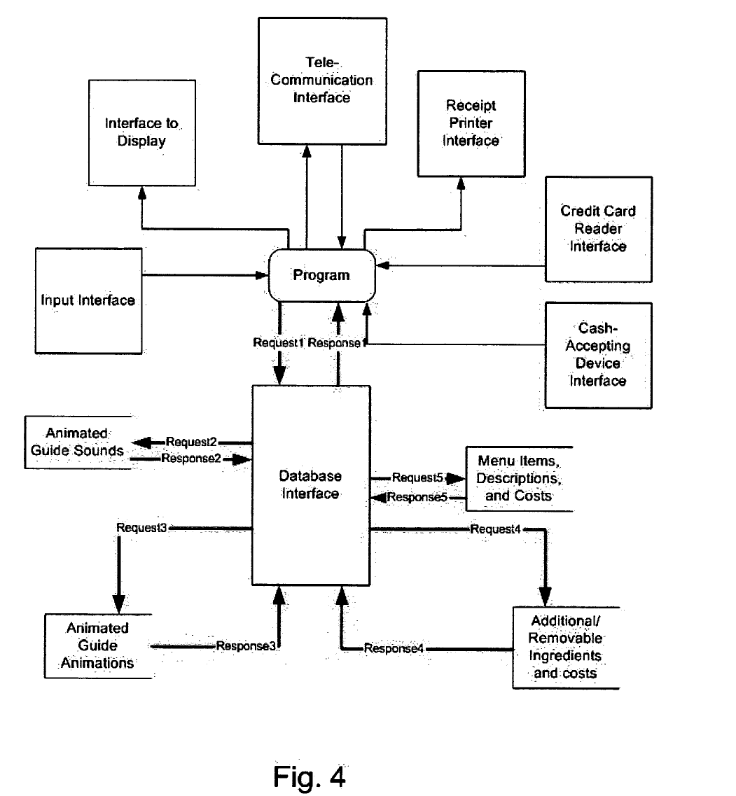

FIG. 4 shows a flowchart of a typical software interface diagram of the system. The software consists of the main program, databases that hold menu items along with costs and descriptions, addable and subtractable ingredients, sounds the animated guide will produce, and the animated pictures or video clips of the animated guide, and interfaces to the display, input system, databases, receipt printer, credit card reader, cash-accepting device, and communications device that could be used to verify the credit card. Interfaces are depicted as a box with four sides while databases are depicted as a box with one open side.

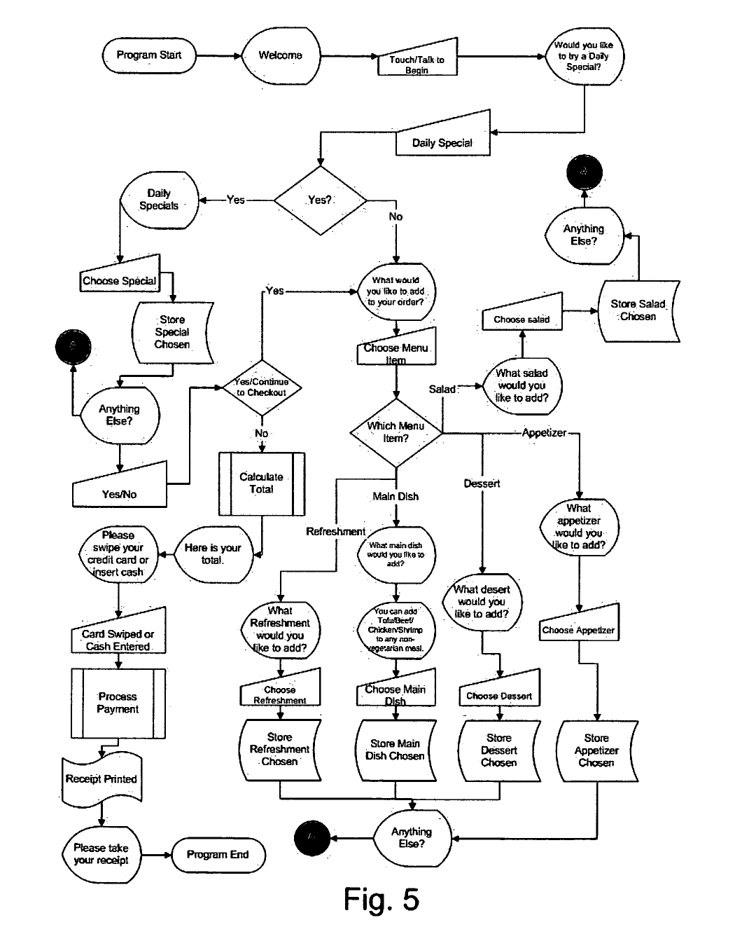

FIG. 5 shows a flowchart of a possible customer interaction with the system. This flowchart shows items to be displayed to the customer via the animated guide, manual input points that could include touching the screen or voice, program flow decision points, and the printing of the receipt once the customer concludes the transaction. The interaction starts with the customer being welcomed to the system by the animated guide. Once the customer starts the system either by touching a screen or by possibly giving a voice command such as “start” or “hello”, the animated guide would then ask the customer if they would like to try a daily special. The user would then reach a decision point whereby they would either touch or say “yes” or “no”. Depending on the response, the interaction would follow the rest of the flowchart with the animated guide asking the customer questions or helpful advice, the user making decisions and inputting their decisions via some type of input. Once the user answered “no” to the question if they would like anything else, then they would proceed to checkout. During the checkout part of the interaction with the kiosk and animated guide, the total would be displayed to the user and they would be prompted to pay for their order either by credit card, cash, or other payment type. The receipt would then be printed, and the user would be prompted to take the receipt and then probably thanked for using the system and their order.

### REFERENCE NUMERALS

11 business name

12 main portion of screen

13 cartoon animated guide

14 overview of customer's order

15 control buttons

16 text cloud showing what the animated guide is saying

17 video-captured animated guide

18 text cloud showing another possible saying for the animated guide

19 monitor that is capable of touch interface

20 computer

21 speaker

22 magnetic card reader

23 receipt printer

24 cash-accepting device

### OPERATION

In operation one uses a potential system incorporating an animated guide by coming up to the system and starting the ordering process in some way, possibly by touching a screen or passing by some detection device such as one that detects people coming to doors. The animated guide could then welcome the customer to the business and prompt them to make ordering decisions specific to each system by numerous methods including by touching parts of a Touchscreen or possibly by voice recognition systems. The animated guide assists the customer or employee by explaining features or other useful information about each part of a potential order, much as a normal employee would. Once the customer or employee was finished with their order, the animated guide would assist the person through the checkout or payment processing part if paying at the system is included. This could include paying by various methods such as credit or debit card, cash, check or other acceptable means of payment. Once the payment is processed, the animated guide would then direct the customer to the receipt of their transaction and probably thank them for doing business with the company. The animated guide would be programmed to act and speak in whatever manner the business would like, and would say whatever the business would want it to say. The animated guide could also be designed using artificial intelligence so that it would be able to interact with customers and employees much more like a normal person would. A typical system would consist of a hardware and software components. FIG. 3 shows the probably main hardware components. These hardware components would consist of a display device such as a touchscreen monitor, a computer to run the software and interface with the peripherals, a credit card reader, a cash-accepting device, and a receipt printer. The computer would typical components such as a central-processing unit, memory, a hard drive, and input/output interface devices. In addition, the computer would also contain a modem or Ethernet device to allow the system to communicate with credit-card verifying companies. Other communications uses could include software changes and updates downloading and remote maintenance. The system would also allow other possible hardware additions such as a microphone for voice-interactions with the customer and infrared detection device so that the system could sense when a potential customer approached. The software that would run on the computer, as shown in FIG. 4, would include the main program that controls the behavior of the animated guide and the interactions with the customer, databases that contain the menu items, costs, and descriptions, addable/subtractable ingredients, the sounds that the animated guide would produce, the files that contain the animations or video clips of the animated guide, and the interfaces to the display, databases, receipt printer, credit card reader, cash-accepting device and the communications device. A typical program flow would include the program displaying a welcome or start system display that was held in the database. Once the user started the system via touching the screen or talking to the system, the program would recognize that input had been made and prompt the user for the next input that was needed. This consists of the program requesting from the databases what to display on the screen. The display could include the animation of the animated guide and the description of the part of the menu that the customer was requesting that shows the menu items available and their costs. If the customer clicked on an individual dish, they would be able to view a large picture of the menu item and a textual description of the item. The program would continue to display options for the user, and accept input in the form of the options that the user had chosen. The input could either be to see another section of the menu or to add a specific menu item to their order. This process would repeat until the user-provided input to the system indicates they are ready to check-out. The program would then calculate the total cost, display it to the customer, and prompt the customer for their payment. The customer would then pay for their order by scanning their credit card, inserting cash into the cash-accepting device, paying by any other possible payment method. Once the payment was received and accepted, the system would then print a receipt on the printer and then thank the customer for their order and patronage.

The animated guide could be produced in a variety of ways. One possible construction of the animated guide could be to video-capture and audio-capture a human being and display the video and audio clips at appropriate times. Another possible animated guide could be a cartoon-like drawing whereby a number of drawings are shown in quick succession giving the illusion that the animated guide is animated. There are many software programs available that allow these animated clips to be produced in various formats.

Advantages

From the description above, a number of advantages of my interactive ordering system become evident:

(a) The animated guide can be customized for each and every application. For example, in one example, the animated guide could be the restaurant's mascot. Another implementation could just have video clips of a human greeter.

(b) The system could be configured for repeat customers and customer satisfaction programs and could easily keep track of and speak people's names if it was programmed to do so.

(c) The system can grow and evolve with the company and the animated guide could easily be re-programmed to say new things as often as the company would like. For example, the animated guide could suggest a new menu item at a restaurant that the restaurant would like “pushed”.

(d) The entire ordering system can be easily upgraded with new features such as an infrared beam to detect when someone walks up to it. Another future possibility would be to add voice recognition capability to the program to make for an even easier and more normal human order-taking. Therefore, the customer could just walk up to the system and start talking to the animated guide, and the program would respond.

### Conclusion, Ramifications, and Scope

Thus the reader will see that the invention provides a very easy-to-use interface that will interact with people on a more personal level than kiosks without an animated guide. Customers will be happy to use a kiosk that can talk them though their ordering experience. Food service companies will be grateful for a system that lowers their labor and training costs, which make up a big percentage of retail and service costs.

While my above descriptions contain many specificities, these should not be construed as limitations on the scope of the invention, but rather as an exemplification of one preferred embodiment thereof. Many other variations are possible. For example, possibly in the future, an artificially intelligent program could interact with the customers.

Accordingly, the scope of the invention should be determined not by the embodiment(s) illustrated, but by the appended claims and their legal equivalents.

1. A method for electronically communicating product information to customers, accepting, and processing orders for food service related products utilizing an animated guide that interacts graphically and by audio with users such as customers and employees and helps to prompt said users through ordering and order processing, comprising the steps of:
(a) providing a first means for displaying said animated guide,
(b) providing a second means for the customer to interact with said system by inputting responses to product options presented to said user on said display means,
(c) providing a third means for said system to respond to input of said user,
(d) providing a fourth means of payment input so that said customer can pay for their order,
(e) providing a fifth means for said system to process said payment,
(f) providing a sixth means for said system to acknowledge receipt of said customer's payment and complete the method of transaction,
whereby said customer will be able to complete an entire order and transaction quickly and easily without the assistance of a human employee by interacting with said animated guide.

2. The method of claim 1 wherein said user of said system interacts with said system by touching items on a means for accepting physical interaction, which could include touching said screen and typing on a keyboard.

3. The method of claim 1 wherein said user of said system interacts with said system by voice commands that are processed using a means for voice recognition.

4. The method of claim 1 wherein said means for inputting payment includes the ability to read magnetic cards such as credit cards and debit cards.

5. The method of claim 1 wherein said means for inputting payment includes the ability to accept hard currency such as paper money and the ability to dispense change.

6. The method of claim 1 wherein said means for processing said payment is handled by a 3^{rd} party means of processing payments external to said system.

7. A device for electronically communicating product information to customers, accepting, and processing orders for food service related products utilizing an animated guide that interacts graphically and by audio with users such as customers and employees and helps to prompt said users through ordering and order processing, comprising the steps of:
(a) providing a system that includes said animated guide
(b) providing a first means for displaying said animated guide that allows said user to interact with said system by inputting responses to product options presented to said user on said display device,
(c) providing a third means for said system to respond to input of said user,
(d) providing a fourth means that accepts payment input so that said customer can pay for their order,
(e) providing a fifth means for said system to process said payment,
(f) providing a sixth means for said system to acknowledge receipt of said customer's payment and complete the method of transaction,
whereby said customer will be able to complete an entire order and transaction quickly and easily without the assistance of a human employee by interacting with said animated guide.

8. The device of claim 1 wherein said user of said system interacts with said system by touching items on a device that accepts physical interaction, which could include touching said screen and typing on a keyboard.

9. The device of claim 1 wherein said user of said system interacts with said system by voice commands that are processed using a means for voice recognition.

10. The device of claim 1 wherein said means for inputting payment includes the ability to read magnetic cards such as credit cards and debit cards.

11. The device of claim 1 wherein said means for inputting payment includes the ability to accept hard currency such as paper money and the ability to dispense change.

12. The device of claim 1 wherein said means for processing said payment is handled by a 3^{rd} party means of processing payments external to said system.
